(19) United States
(12) Patent Application Publication
(10) Pub. No.: US 2017/0293864 A1
(43) Pub. Date: Oct. 12, 2017

(54) System and Method for Searching and Matching Content Over Social Networks Relevant to an Individual

(71) Applicant: BPU International, Inc., Las Vegas, NV (US)

(72) Inventors: Sanggyoon Oh, Las Vegas, NV (US); Carlos A. Nevarez, Las Vegas, NV (US)

(21) Appl. No.: 15/483,206

(22) Filed: Apr. 10, 2017

Related U.S. Application Data
(60) Provisional application No. 62/319,905, filed on Apr. 8, 2016.

(51) Int. Cl. G06N 99/00; G06F 17/30

(52) U.S. Cl. CPC G06N 99/005; G06F 17/30516; G06F 17/30699; G06F 17/30684; G06F 17/3053

(57) ABSTRACT

The present invention is directed at a system and method for searching and matching content over social networks relevant to a specific individual. In an aspect, the individual relevant content search system provides search results and information that is relevant to the individual's perspective.

### CROSS-REFERENCE TO RELATED APPLICATION

This application claims the benefit of U.S. Provisional Application No. 62/319,905, filed on Apr. 8, 2016, the entirety of which is incorporation herein by this reference.

### FIELD OF THE INVENTION

The present invention relates to network search engines.

### BACKGROUND OF THE INVENTION

In essence, the Internet is a set of databases that organize information into domain-specific data, social data, business data, blogging data, searching data, etc. Further, there are numerous search engines associated with the internet that provide information to their users. Actual search engines, such as Google, Yahoo, Bing, Ask.com, and many others, have built wonderful searching systems. However, these systems have not succeeded in providing a way to “search the search”. In addition, the information that is returned is not relevant to the individual doing the search, but just the information itself. The information is relevant only in terms of the search term; there is no information related to the individual.

Therefore, there is a need for a search system that produces information that is relevant to the individual themselves, as well as a system that searches the search.

### SUMMARY OF THE INVENTION

The present invention is directed at a system and method for searching and matching content over social networks relevant to a specific individual. In an aspect, the individual relevant content search system provides search results and information that is relevant to the individual's perspective. In other words, the system provides information from the user's point of view, whereas other prior art systems offer a global point of view.

In an aspect, the individual relevant content search (IRCS) system is configured to return information specific to the individual by communicating with at least one user device associated with the individual and social media servers with which the individual utilizes, obtain information from the user device and social media accounts associated with the individual to create a data stream; and analyze the data stream to determine insights of the individual. In an aspect, the IRCS system can create the data stream by taking data related to the individual from the social media accounts associated with the individual and assembling the data into a normalized data representation. In another aspect, the IRCS system assembles the data further by assembling structured and unstructured data into the data stream. In another aspect, the IRCS system can use APIs to acquire the structured data and a scraper to acquire the unstructured data. In another aspect, the IRCS system to can assemble the data by using domain specific information and metadata to create packets that separate the metadata and content to form the data stream.

In an aspect, the IRCS system analyzes the data by learning about the data and analyzing the data. In such aspects, the IRCS system can learn about the data by comprises applying concept dictionaries on the data and mapping patterns based upon the concept dictionaries. In such aspects, the IRCS system can apply personal preferences of an individual to the pattern maps, and/or build personal dictionaries based upon the concept dictionaries and pattern mapping. The IRCS system can also learn about the data by tokenizing the data.

In an aspect, the IRCS system can analyze the data by determining relevance, semantics, sentiment, and intent of the data. In such aspects, the IRCS system can determine the relevance of the data by grouping terms from the data together and ranking the terms, which can include creating values for terms via measuring the frequency and density of the terms. In other aspects, the IRCS system can determine semantics of the data by asking the user to train the system (i.e., providing feedback and own meanings to the terms).

These and other aspects of the invention can be realized from a reading and understanding of the detailed description and drawings.

### BRIEF DESCRIPTION OF THE DRAWINGS

FIG. 1 illustrates a schematic representation of the social media platforms from which the individual relevant content search system pulls according to an aspect of the present invention.

FIG. 2 illustrates a schematic representation of the individual relevant content search system according to an aspect of the present invention.

FIGS. 3 and 5-8 illustrate schematic representations of the individual relevant content search server of FIG. 2 communicating with social media servers according to an aspect of the present invention.

FIG. 4 illustrates a schematic representation of the individual relevant content search server of FIG. 2 according to an aspect of the present invention.

FIG. 9 illustrates a schematic representation of data packets created by a data ingestion module of the individual content search server according to an aspect of the present invention.

FIG. 10 illustrates a schematic representation of a data learning module of the individual content search server according to an aspect of the present invention.

FIG. 11 is a schematic representation of an analysis module of the individual content search server according to an aspect of the present invention.

FIG. 12 is a schematic representation of a profiling module of the individual content search server according to an aspect of the present invention.

FIGS. 13-14 illustrate schematic representations of a user device and a individual content search server respectively according to an aspect of the present invention.

FIGS. 15-20 capture screen shots generated by the individual relevant content search system according to an aspect of the present invention.

### DETAILED DESCRIPTION OF THE INVENTION

The present invention will now be described more fully hereinafter with reference to the accompanying drawings, which are intended to be read in conjunction with this detailed description, the summary, and any preferred and/or particular embodiments specifically discussed or otherwise disclosed. This invention may, however, be embodied in many different forms and should not be construed as limited to the embodiments set forth herein. Instead, these embodiments are provided by way of illustration only and so that this disclosure will be thorough, complete and will fully convey the full scope of the invention to those skilled in the art.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers, remote located servers, user devices, or cloud services. Any suitable computer-readable storage medium may be utilized including hard disks, CD-ROMs, optical storage devices, or magnetic storage devices. In an aspect, the methods and systems discussed below can take the form of function specific machines, computers, and/or computer program instructions.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions may be loaded onto a special purpose computer, special purpose computers and components found in cloud services, or other specific programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks. The computer program instructions, logic, intelligence can also be stored and implemented on a chip or other hardware components.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

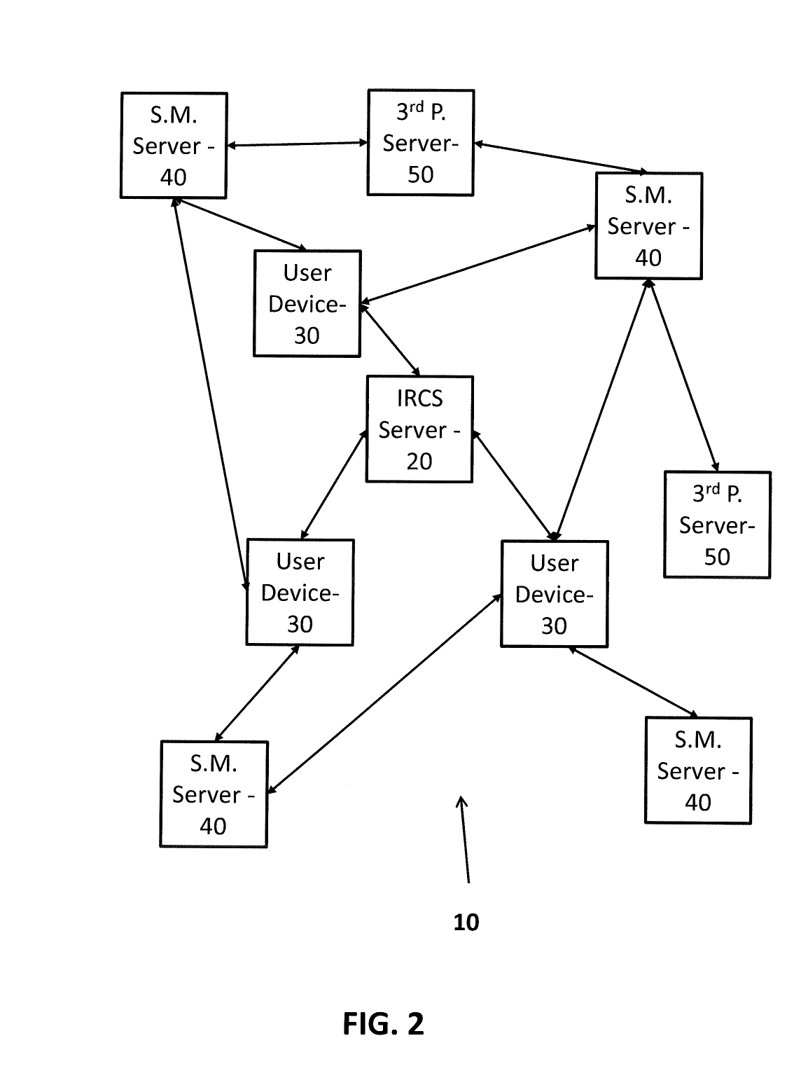

The system and method for searching and matching content over social networks relevant to an individual is described herein. As discussed above, the individual relevant content search (IRCS) system 10, as shown in FIGS. 2-20, is designed to return information to the user that is specific to the individual. In an aspect, the IRCS system 10 provides search results and information that is relevant to the individual's perspective. In other words, the system provides information from the user's point of view. The IRCS system 10 provides the infrastructure that allows both the anonymous, as well as the secure, personally identifiable information to be used to improve the human condition. In a sense, the IRCS system 10 becomes intelligent by combining human language with machine processing of stored knowledge. In an aspect, the IRCS system, a new type of “search engine”, is designed to fuel new human applications based on what is relevant, and meaningful to the individual user; it is based on how the user feels and how the world around the user feels about something, and more importantly what the user intends to do with that information.

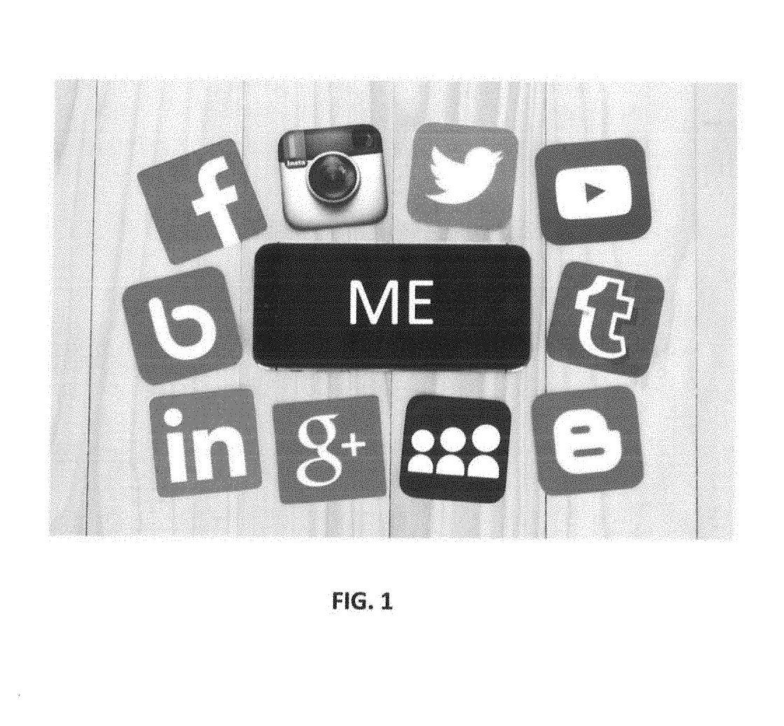

In some instances, the IRCS system 10 can utilize the individual's social media accounts to provide such information. FIG. 1 illustrates several social media platforms from which the information can be pulled. FIG. 1, however, is just an illustrative example; the social media platforms can include, but not limited to, Facebook®, Instagram®, Twitter®, YouTube®, Tumblr®, Blogger®, Pintrest®, Google+®, LinkedIn®, Periscope®, Meerkat®, Vimeo®, Snapchat®, Blab®, Flickr®, Medium®, WordPress®, Reddit®, and the like. To put the IRCS system 10 in perspective to those of well-established search engines like Google, Google asks what the trees look like from the perspective of the forest. The IRCS system 10, according to an aspect, asks what the forest looks like from the perspective of the tree.

From a very high-level, every social media system out there, including, but not limited to, Google, Facebook, Twitter, and the like, consists of a very large database of users, the users' content (or their searches) and the relationships between them. Most, if not all, of these social media systems provide a way to search for people, their groups, or their pages, and their posts, and provide ways to find out other related information based on those searches. In a sense, the Internet is a set of databases that organize information into domain-specific data, social data, business data, blogging data, searching data, etc. In essence, these are databases for the purpose of finding (and searching) things that users like and identifying those likes, many times tagging this information. The indication of the likes can be utilized by the IRCS system 10 to identify what a user likes or relates to. By allowing the linking of data from one of these domains to the next, say Google to Facebook, Facebook to twitter, etc., the individuals have given rise to identifiable patterns and preferences that can be used and even exploited to reach these individuals. In the end, this “cloud” of services and databases we call The Internet, is really all about each user.

FIG.2 illustrates the IRCS system 10 according to an aspect of the present invention. The IRCS system 10 can utilize an IRCS server 20 that is configured to communicate with devices 30 associated with various users. The user devices 30 are in contact with social media servers (S.M.) 40 with which the user of the device 30 has an account. In addition, the social media servers 40 can be accessed by the IRCS server 20 via permissions provided by the user of the user device 30. In some aspects, other third party (3^{rd}P) servers 50 (e.g., marketing and content providers) can be accessed by the IRCS server 20 through the user devices 30 and the social medial servers 40.

The IRCS server 20 is configured to provide the majority of the functionality and analysis of the IRCS system 10, described in more detail below. However, in some aspects, the IRCS system 10, via the IRCS server 20 and the user devices 30, via self-contained processing machines (SCPM) 35, discussed in more detail below, is configured to share some functionality amongst different participants. In some aspects, certain software and hardware components of the IRCS system 10 can be shared, split, and/or hosted simultaneously amongst the user devices 30 and the IRCS server 20.

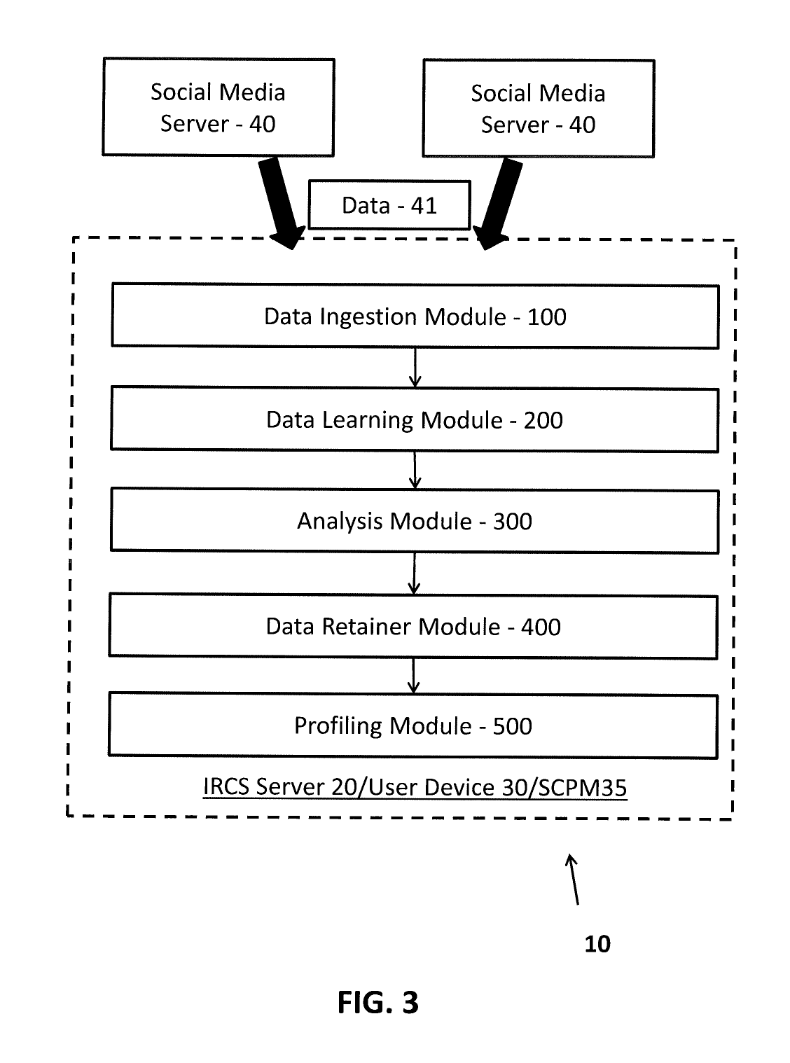

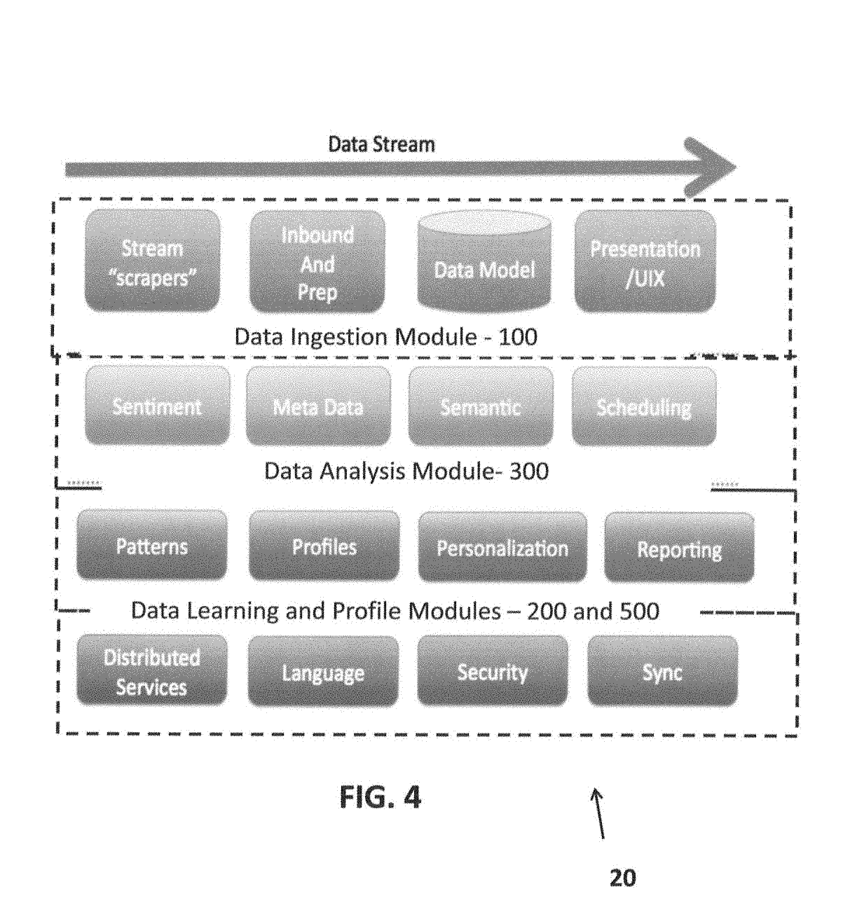

In an aspect, the IRCS system 10 is configured to analyze data 41, gathered from various sources, including social mead platforms/servers 40, related to an individual and return results based upon the individual. In other aspects, the IRCS system 10 can analyze data 41 and return the results of all users, or just portions. The IRCS system 10 utilizes a number of modules to perform the various analyses and functions, as shown in FIGS. 3-4. In an aspect, the IRCS system 10 can include a data ingestion module 100, a data learning module 200, an analysis module 300, a data retainer module 400, and a profiling module 500. These modules, as shown in FIG. 4, along with other components, can prepare data streams through various means, analyze collected data, make intelligent insights about the data, and provide various other types of services. As stated above, these modules and functionality can be carried out by components be shared amongst the IRCS server 20 and the user devices 30/SCPM 35 dependent on the functionality provided by the components.

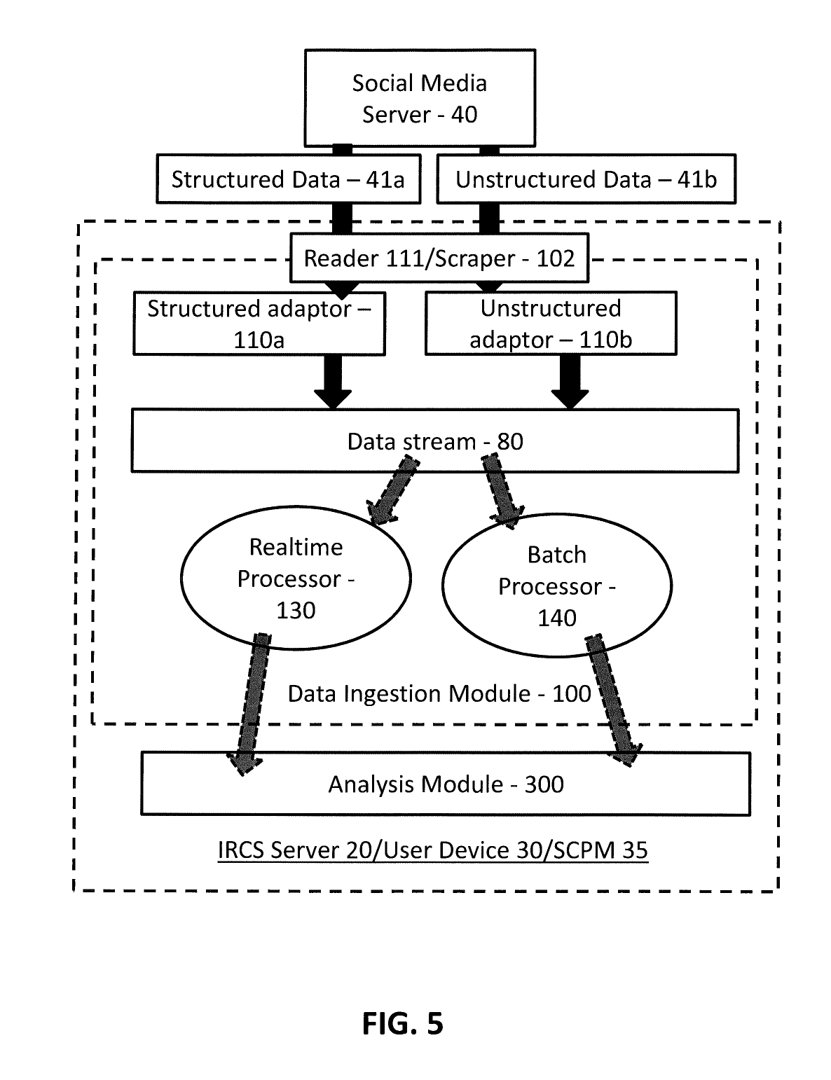

The data ingestion module 100 is a highly adaptable module that is used to inbound streams of data 41, which can be structured 41a or unstructured 41b to form data streams, as shown in FIGS. 4 and 5. The data ingestion module 100 is configured to learn the necessary requirements of the various social media platforms/servers 40 from which it pulls information/data 41, and can adapt to the necessary interfaces on these platforms/servers 40 in order to produce a data stream 80 that can be accepted by the other modules of the IRCS system 10. The IRCS system 10 supports a great deal of flexibility. Data 41 can be “adapted” using a stream “scraper” interface 102, because in some instances the data 60 may not be available as a stream, or an API, and in some instances it may be necessary to actually parse and pre-process data before it is submitted, as discussed below. This greatly simplifies the IRCS system 10 in that, outside of the data ingestion module 100, the IRCS system 10 views the inbound data 41 as a data stream 80. Once the stream 80 is ready, the inbound and prep services take over. For example it may be necessary to have a person's individual login to access the particular stream.

Using a data stream 80 has several benefits. In an aspect, one benefit is that the data stream 80 does not have to be separately accumulated and stored for analysis; the data 41, in the form of the data stream 80, is taken as it is. In addition, a data stream 80 can be fed in the IRCS system 10 multiple times (e.g., recursively), refining the data stream 80 further each time, which eliminated “noise” typically created when sifting through large data sets.

Data 41 on the internet poses a problem: the format and structure of data 41 varies from one site to the next. In addition, with the preponderance of content sites (e.g., Instagram, Facebook, etc., hosted by the social media servers 40), data is becoming more and more tagged. Therefore, the IRCS system 10, and more specifically the data ingestion module 100, has more and more clues about what the data 41 is about without necessarily having to look at the data itself. However, internet users interpret things differently, and given that most of the data 41 collected from the social media platforms/servers 40 (via the accounts of the user of the user devices 30) is public, volunteered information is not really reliable. The data ingestion module 100 utilizes automated ways to better understand the data 41.

From a very high-level, the data ingestion module 100 discriminates between structured 41a and unstructured data 41b. In an aspect, the data ingestion module 100 can identify these different types of data 41. In such aspects, it is possible that each type of data requires a different type of adaptor or agent, a structured adaptor/agent 110a and an unstructured adaptor/agent 110b, as shown in FIG. 5. One job these adapters 110 have s take the data 41 from the social media servers 40 and convert it to a data stream 80. This way, the real-time processor 130 and batch processor 140, discussed below, don't have to worry about the different types of data 41 from the various social media servers 40; the data 41, structured 41a or unstructured 41b, is shown through a single data stream 80. Processing either happens in real-time, via a real-time processor 130, or it happens in “batch” mode, via the batch processor 140, which means that at some scheduled time, the processes run and interpret the stream 80 extracting the necessary analysis.

As shown in FIGS. 4-6, the data agents/adaptors 110 sole job is to adapt the data 41 from whatever source 40 (FB, Twitter, YouTube, Naver, unstructured data) and create a normalized data representation which then becomes the data stream 80. This normalization does not just simply convert data from one format to another; the inbound data adaptors 110 check the context of the data 41 for interpretation. That is, the data adaptors 110 determine if biases and preferences of the user associated with the data 41 should be prioritized over the same of IRCS system 10. In an aspect, a user can configure settings associated with the adaptors 110 to give more or less weight to a personal dictionary or a general dictionary, found within the data learning module 200 (discussed further below), in order to assist in interpreting the data.

In an aspect, the data stream 80 is a set of internal databases, some of which operate in “real” time, and some in “batch” mode. Beyond that point, the data analysis modules/engines 300, discussed below, uses common algorithms for determining relevance and sentiment (discussed in detail below), and common services for maintaining trends, scoring and long-term reports (common, in this context, means shared between the different components of the architecture). The IRCS system 10 also begins to form the “intelligence” basis by modeling the data that it's ingesting.

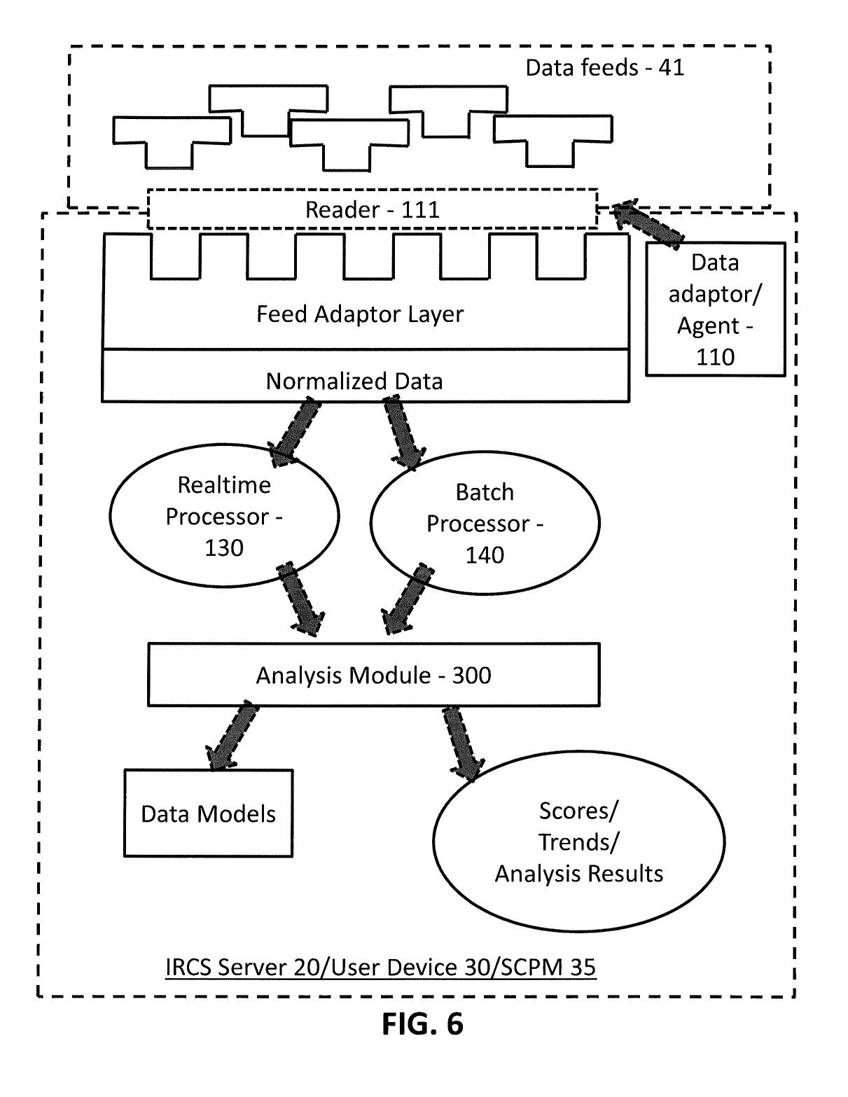

As mentioned before, the data agents/adaptors 110 are the part of the data ingestion module 100 that understands what the data 41 looks like. In an aspect, the data agent(s) 110 uses domain specific information and metadata to create a structure that represents the metadata 41c (data about the post) and the actual content of the post 41d (Post Data) (see FIG. 6). By aggregating all these structures, a data stream 80 of packets is formed.

There is another interesting aspect to the data ingestion module 100 that makes it intelligent. Normally, when this type of architecture is used, the data agent/adaptor 110 is language-specific; in other words, there is a Facebook agent for every language supported, FB Spanish, FB English, FB Korean, etc. The problem with having these data agents/adaptors 110 completely independent of each other is that any potential semantic synergy between them gets lost. This is where having interaction with a person allows the IRCS system 10, and specifically data learning module 200 along with the data agents 110 of the data ingestion module 100, to “learn” and the human to teach the IRCS system 10.

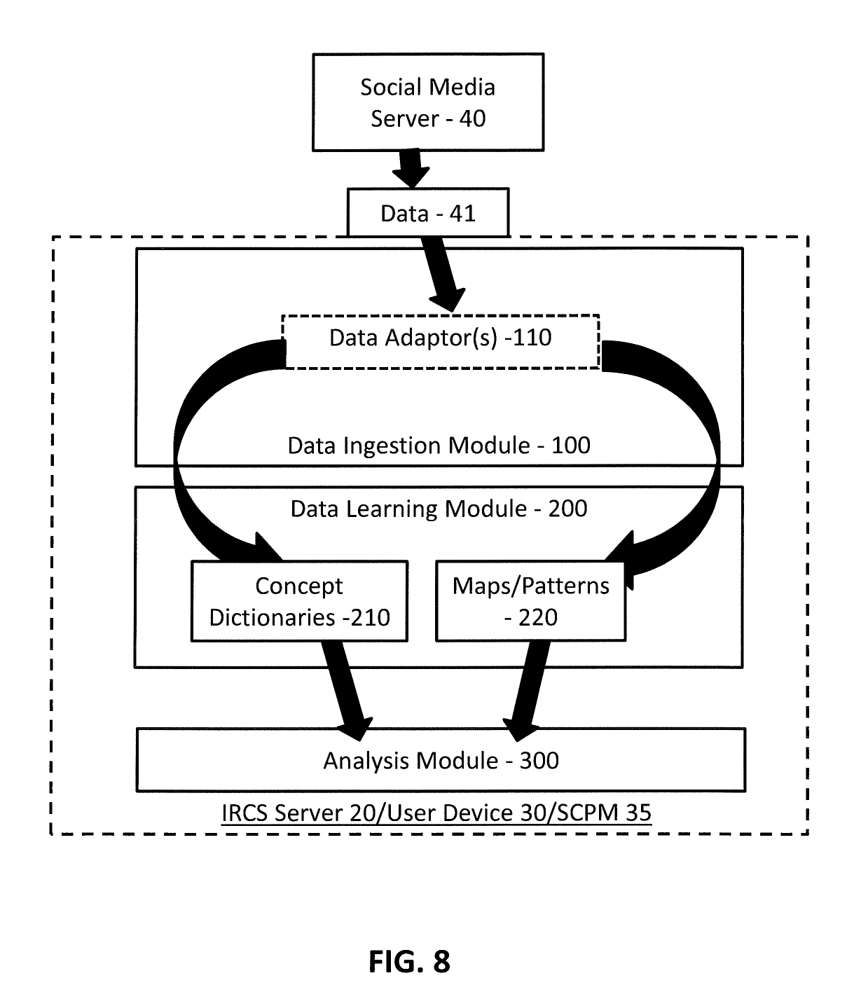

In an aspect, the data learning module 200, with assistance from the data ingestion module 100, can come to understand the data 41 through establishing concept dictionaries 210 and mapping or establishing patterns 220 of the information based upon concepts (see FIG. 8). Concepts are language independent constructs that can be used to map the inbound posts/data 41. Further, the data learning module 200 will then take the concept and see if a consensus can be determined from additional data, from one to all users. The more consensus builds about the “meaning” of a particular concept, the less work that has to be done during ingestion. Once the consensus is built, the data learning module 200 can then begin to map other information found with proven concepts to the same concept.

For example, a heart emoji can be linked to the concept of love. The data ingestion module 100 can also allow a user to suggest to the IRCS system 10 that the heart represents love. The IRCS system 10 then proposes the concept (i.e., the heart emoji equals love) for general consideration within the concept dictionary 210 and/or the patterns 220. As more and more data of the user, as well as other users, shows the emoji equals love, a consensus is being built. For example, the learning module 200 will look to see if posts 41 that includes a bunch of hearts are likely to be about love, and probably positive about love. Once the concept has been built and to a certain extent verified, the data learning module 200 can then further process a post and map the natural language to terms often associated with love. Therefore, it is possible to infuse semantic metadata into the data stream 80. Further, the metadata includes geolocation, demographic, chronological, device, source, etc., or anything that can be obtained about that data 41 to help increase the value of the analysis.

In an aspect, the data learning module 200, utilizing the data adaptors 110 of the data ingestion module 100, use intelligence in two primary ways: (1) applying personal preferences to the concept dictionaries 210 used for understanding the incoming data; and (2) building conceptual “maps” and patterns 220 to be applied in the future when encountering the same concepts and patterns. These steps are done within the data learning module 200, as shown in FIG. 8. These concepts/dictionaries 210 and patterns/maps 220 can then be used later on by the analysis module 300 to perform further work and to provide even more services to the person using the IRCS system 10. In other words, the data ingestion module 100 detects the data, and the data learning module 200 acquires the concepts and patterns.

When a user device 30 first uses the IRCS system 10, the IRCS system 10 has no knowledge of the user, and forces connections/concepts on the user's data 41. However, once the IRCS system 10 learns some of the patterns and concepts in the data stream 80 (which can be retained in the data retainer module 400), the IRCS system 10 can call on the data learning module 200 to feed these concepts (e.g., from the concept dictionaries 210) back to the data ingestion module 100 so the data ingestion module 100 has less work to do, skipping recognized concepts.

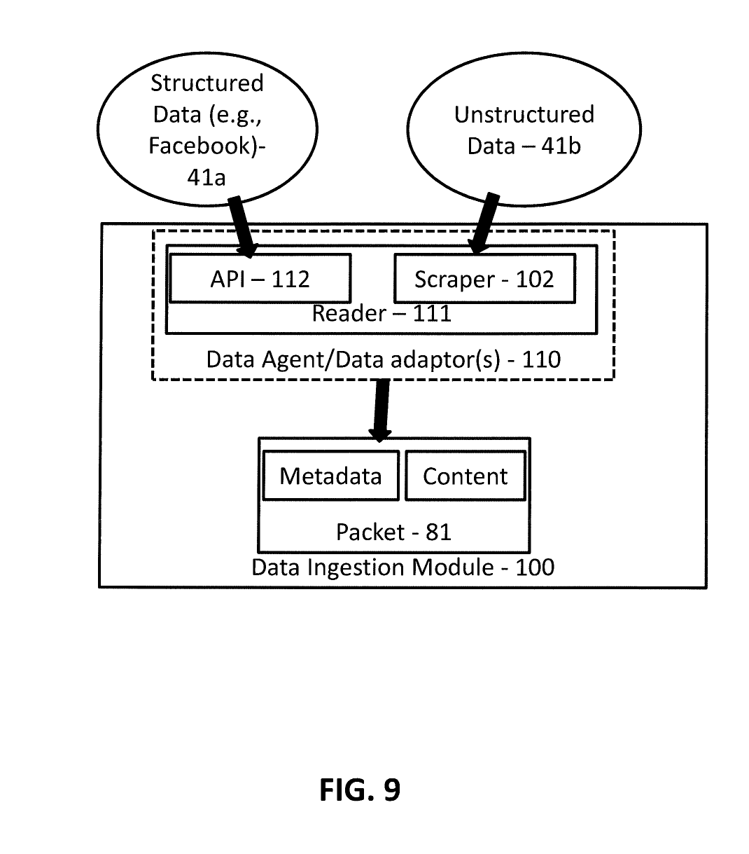

In an aspect, the data adaptors 110 include a feed reader 111, which acquires the contents of a feed 41 from a particular source such as Facebook, Twitter, YouTube, etc., as shown in FIGS. 6 and 9. Many times these feeds 41 have an API 112, and the data adaptor 110 simply simulates the user, using the person's login credentials, and obtains the feed 41 as if it were the person viewing the feed 41. Sometimes, though, it's not feasible to use the API 112, or not available, and the feed reader 111 uses what is commonly referred to as a scraper 102. The scraper 102 can parse the native content, usually in HTML, and separating the content from the visual format. Native search capabilities can also be used to retrieve content, through the use of the user's account.

The reader 111 uses public or internal knowledge of the data structure to create a “packet” 81 that separates the metadata from the actual content of each individual post. This is done prior to parsing the content (i.e., forming the data stream 80) for analysis. In an aspect, this type of processing moves closer to the user in the form of distributed agents on the user device 30, more “pre-analysis” will be pushed to this initial ingestion phase. Through this process, the data 41 from the social media servers 40 is not coming from a fire hose; the data 41 is being “scraped” from individual accounts of the individuals as authorized by the user when they setup an account with IRCS system 10. The data ingestion module 100 provides a reasonable place to use intelligence as it builds. Further, the data ingestion module 100, with the data learning module 200, intakes the data 41 on a user's individual basis, avoiding the normal Big Data problem associated with such data acquisition. In an aspect, once the data 41 is analyzed, discussed in detail below, the data 41 quickly goes away. In other words, processing a post is similar to processing short-term memory, whereas long-term memory is to remember conceptual learning.

In an aspect, the combination of the data ingestion module 100 and the data learning module 200 creates a language-independent database of concepts 210 and patterns 220. All individuals follow individual linguistic patterns when communicating. Because the data adaptors 110 of the data ingestion module 100 are many times “impersonating” the individual, it is efficient to embed the conceptual and pattern intelligence (i.e., the data learning module 200) within the data ingestion module 100 as the data 41 is being read rather than having to “re-read” the data later in the analysis phase. In an aspect, the two modules 100 and 200 can be found on the SCPM 35 on a user's device 30. In such aspects, having the personal pattern recognition (combination of the data ingestion and learning modules 100 and 200) distributed on the user device 30 lowers the load on the IRCS server 20, while increasing the affinity to the individual patterns and preferences without taxing IRCS server 20.

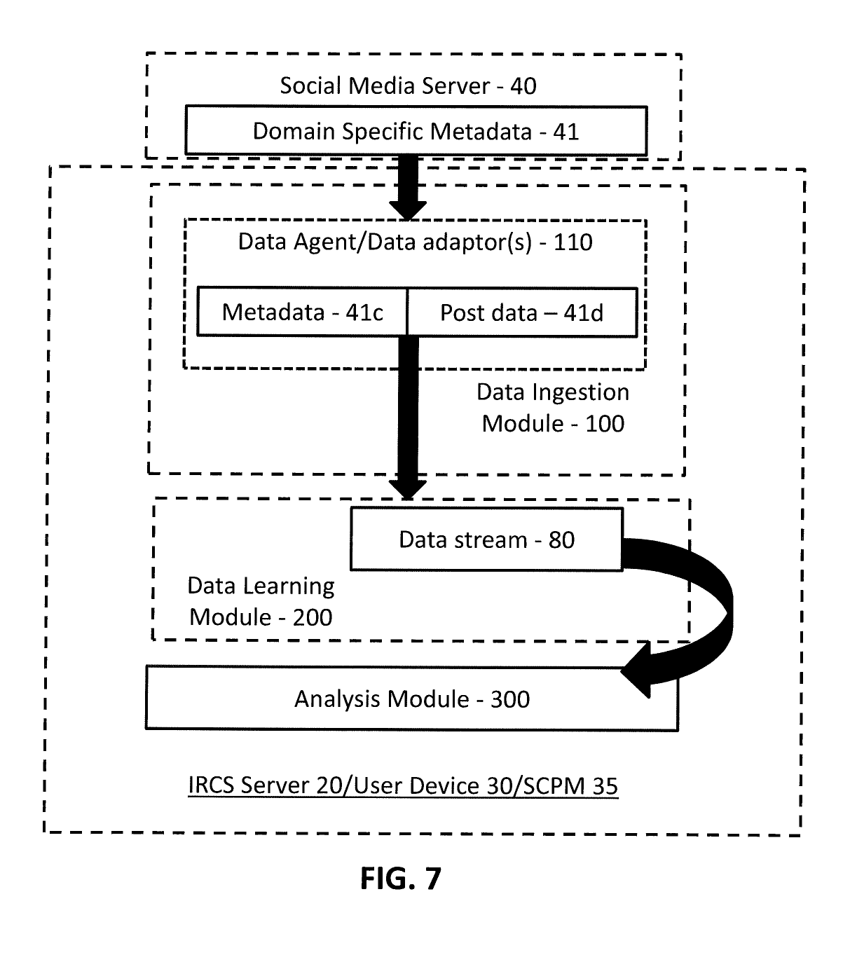

FIGS. 7 and 9-10 illustrate examples of the flow of information between components of the data learning module 200. Let's suppose an individual posted a sentence 41 on Facebook stating “I just love “heart emoji” pretty flowers in the spring.” A common language parser 230, utilizing general language dictionaries 205 and concepts 210, tokenizes the original sentence 41 to create a tokenized sentence 84 using simple language analysis to create a data structure (linked list, tree, etc.) containing tokens 85. In this case the individual used the heart emoji which Facebook displays as a heart. The heart emoji is understood to a Facebook user, but not to a natural language parser. So intelligence has to be used here by using domain-specific information (see FIG. 7) to separate the natural language from other artifacts. Similarly, if the same individual starts using hashtags so she rephrases her post: “I just #love “heart emoji” pretty #flowers in the #spring”, domain-specific information needs to be used to capture the “heart emoji” #love, #flowers and #spring into the metadata as descriptive artifacts and re-post the natural language back into the processor(s) 130/140 without all the escape characters that would usually create a lot of problems for a regular parser. Further, this process is localized and adapted to each language supported by the tool so colloquialisms, cultural references, and other local language and culture biases can be accounted for.

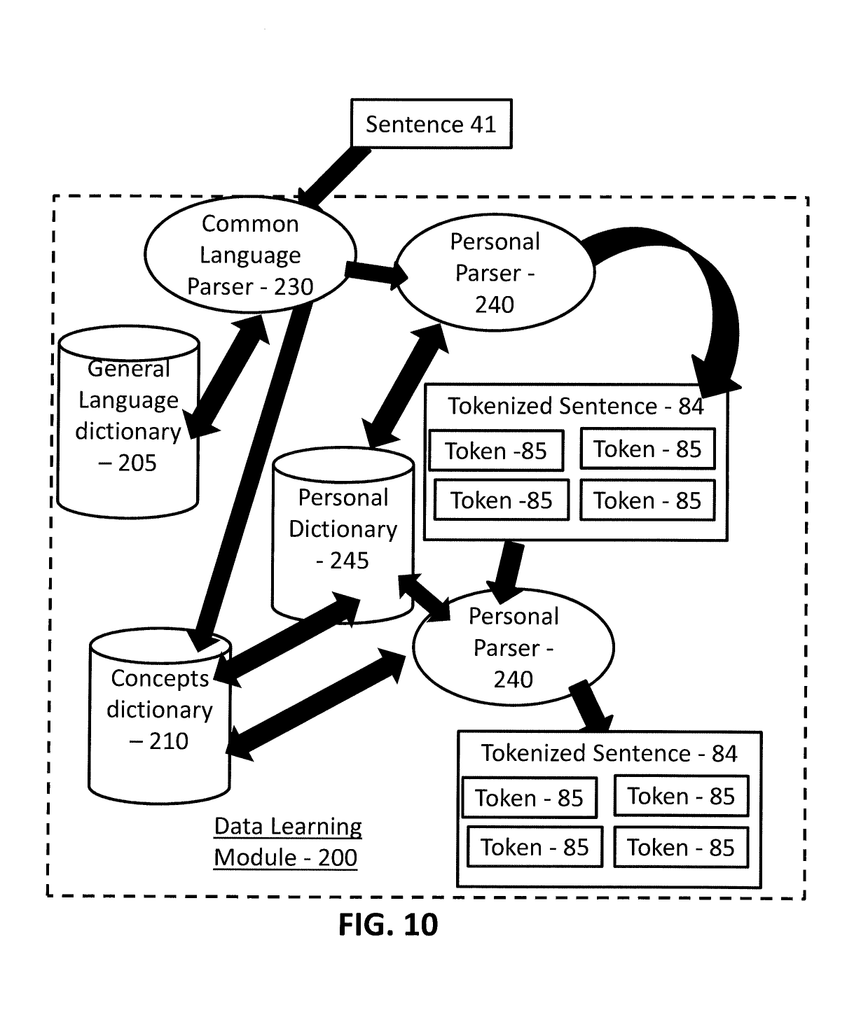

Returning to the original sentence “I just love “heart emoji” pretty flowers in the spring”, the data learning module 200 constructs a personal dictionary 245, along with the parser 240, still using the concepts dictionary 210, to capture the meaning of the sentence (see FIG. 10). Does the user mean that she only loves pretty flowers? Does she love all flowers since flowers are all pretty? Does she “just love” and not have any other emotion for flowers? Or does she love pretty flowers just in the spring? As shown, the semantics can be quite context-sensitive to the individual. This type of personalized parsing 240 does not preclude general parsing. However by replacing parts of language already parsed by the personal dictionary 245 rules with tokens 85, the general parser 230 has less work to do.

The tokenization of the sentence can continue for additional cycles, as shown in FIG. 10. Each “cycle” in the parsing adds more and more ‘intelligence’ to understanding what the individual truly means. Over time, as more and more of the linguistic patterns are established by an individual, and, by providing a method for the individual to review their concepts and score their semantic matches, the engine can be trained for more accurate understanding of those patterns, concepts and semantics.

Tokens 85 become powerful when a sentence is being deconstructed for actual analysis, eliminating the need to do additional work to understanding what that token “means”. For example, natural language parsing (done by general language parser 230) requires the deconstruction into linguistic elements (e.g., noun, verb, adjective, etc.) then matching the linguistic elements to speech patterns to establish what is being said. With tokens 85, this is no longer necessary, because the token 85 has already been “matched”. Thus over time, since people use repetitive patterns in their language, the actual “nitty-gritty” parsing becomes less and less necessary as their posts quickly get matched to one of their patterns (via the pattern/maps 220) by the pre-processing, resulting not only in faster but extremely accurate processing.

The data learning module 200 can further extract more data about the data, creates data structures (i.e., packets) 81 within the stream 80 and schedules processing of the data stream 80 (See FIG. 9). Pattern recognition and other algorithms can be used for a better understanding of the data. This type of data analysis is useful for better targeting marketing messages, and to allow for commercial and social activities based on patterns, as opposed to the specific contents.

After all the packets 81 are placed into the data stream 80, the packets 81 are then received by the analysis module 300. The analysis module 300 can perform diverse analytics (sentiment, semantics, etc.) as requested or configured for that data stream 80. The analysis module 300 can be comprised of a plurality of analysis modules/engines. For example, there are different types of sentiment analysis engines and some can analyze twitter feeds, but not others, so it's important to be able to “plug-and-play” different engines. Also, some engines are based on natural language processing algorithms while others focus on contextual and metadata. Because of this a data stream 80 can be seen as a series of processors acting on the data as it moves along the processing path. The processors/engines are not limited in what they do, whether it's semantic analysis, or metadata extraction, the analysis is only limited by the rules applied to the data stream 80. The analysis module 300 also allows the scheduling of processing to happen in real-time, batch mode or offline. The processing does not have to happen sequentially and can be distributed. The scheduling system also manages the synchronization with the different service providers.

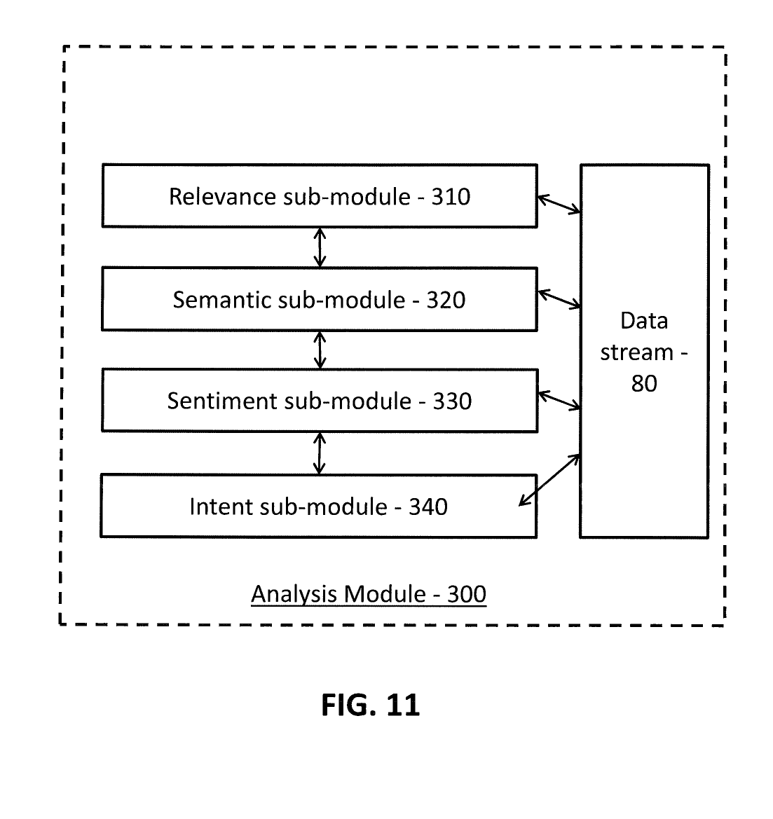

The IRCS system 10 of the present invention produces search results that are relevant to the individual. The IRCS system 10 performs these searches and analysis via the analysis module 300, which is based upon and uses four main concepts and related sub-modules: relevance 310, semantics 320, sentiment 330, and intent 340, as shown in FIG. 11.

### Relevance

Relevance is a broad term. As it applies to searching of the IRCS system 10, relevance, via a relevance sub-module 310, is used to group terms together. So for example, if someone types in “Hillary”, the IRCS system 10 would then look at what the search returns, and rank the most common term used next to “Hillary”. This ranking of terms can be done by looking at different factors, like frequency, how often does “Clinton” appear in posts after “Hillary”? How often does “President” or “Candidate”? Term frequency-inverse document frequency (numerical statistic that is intended to reflect how important a word is) can be utilized for this ranking.

All these different values that can be assigned to a term can be compounded to expand to phrases, paragraphs, and to entire documents. By creating a numerical model of a document, comparisons can be made without having to compare terms to each other, or even searching for the appearance of a term. For example, assume that simple binary encoding (ASCII) is used for the term “relevance”. The hex 72656C6576616E6365 is produced—which could easily be expanded to 0's and 1's and which can then be easily and quickly evaluated against other terms using simple binary math (OR, XOR, etc.) and can also be quickly organized into tree structures by comparing the simple value to other word's simple values.

By organizing a phrase or even a document in this fashion, the relevance sub-module 310 can then create bitmaps to represent these complete documents. Further, comparisons can be done at the bit level rather than try to compare character by character. By adding additional functions to the value, i.e. density, weight, frequency, traditional math can be used to compare these “physical” characteristics of the content without actually having to individually look at the words themselves. However, given that any two bitmaps look similar or even identical, the likelihood that they represent something very similar is very high, and inversely, if they don't match, they won't be very similar at all. This allows the IRCS system 10 to create libraries of “learned” entire topics and can quickly identify similar patterns simply by comparing bitmaps.

In addition, the relevance sub-module 310 can also consider the concept of density, in any given group of posts, is the frequency high, or is it distributed (some posts have lots of mentions, others have less). The point is that regardless of how the math is constructed, an algorithm or a set of algorithms can be created that after testing and training (i.e., the user function which takes user feedback and creates user or perhaps domain-specific dictionaries that can be used by the algorithms in trying to determine the relative value of one term to another) will generate what is would “commonly” refer to as relevance. This would be a numeric value based on calculations of frequency and density applied over some particular time value. Therefore, a term used frequently and densely has more relevance to a user than a term seldom used. The IRCS system 10 is generating and identifying patterns, not simply trying to identify commonly used terms.

To determine the relevance of other terms to the original term, or to calculate the relevance of the actual term to the individual, the IRCS system 10, via the relevance sub-module 310 looks at the similar frequency and density measurements over time in the user's own use, i.e. the user's messages, posts, searches, etc. By looking at the user's friend's streams, the IRCS system 10 can determine how often the term is showing up in the user's circle of friends, making it more relevant to more friends the user has that are searching and using the same term.

As the IRCS system 10 starts capturing relationships between users (people), and not just terms, the IRCS system 10 starts adding attributes of frequency, weight, volume, density, etc. to the elements that are measured about a relationship. As discussed above, if a term is important to a friend of the user (because they use it frequently or densely over a period of time) then the IRCS system 10, via the relevance sub-module 310, can match that “pattern” to the user to see how alike the friends and user are. Visualize for a moment that frequency is a sine wave, with the density being the distance between peaks (and troughs). If the density is high then the wave looks like a bunch of peaks very close to each other. If the density is low the waves will look long.

By looking at these “wave” patterns, the pattern can be converted to a function. The function can then be compared to other functions to detect and compare the pattern, which is easily done mathematically since every wave can be mapped to a sine function, and by comparing the functions and the aspects of the function the IRCS system 10 can avoid having to compare the waves themselves. Comparing a function such as f(i)=x(i) is simple in binary. Further, by turning words into mathematical constructs (e.g. waves) allows the IRCS system 10 to use well established math without the need to invent new math.

By mapping each term to a mathematical function or value, simple questions can be asked: is it equal, less than or greater than, etc. The IRCS system 10, via the relevance sub-module 310, can then establish the term's position against other terms on a number line and thus determine what portion of a number line is more or less relevant to a particular individual. The IRCS system 10 can use relevance and semantic models to create attributes identifying a person's linguistic patterns and signature by converting the linguistic constructs into simple functions that are easily evaluated. And by evaluating a function, the actual language is evaluated only when absolutely necessary. As global linguistic patterns are developed, incredible efficiencies are created through the avoidance of linguistic and cultural differences across locales.

For example, starting with Facebook as the primary driver for detecting relationships between people; “me” is the person using the IRCS system 10. Other users of the IRCS system 10 use their Facebook account to look through their “Friends”, their “Likes”, their “Followers”, and their “Mentions”. Based on those elements alone, the IRCS system 10 can build a map of those people and assign relevance scores based on how many times someone likes my posts, or how often they share them with others. In fact, one can think of a dimensional graph where people who have the most interactions with me are “nearer” to me and others are further.

The IRCS system 10 is different in that it can also score (and retain that scoring over time) the sentiment (discussed below) of those posts and create a combined sentiment-relevance score that can more accurately represent how people truly feel about me (i.e., the user), and who is more likely to agree with me based on what they say and do. Similarly, the inverse can also be made true. Information from the posts/shares/likes of the user id taken, and then are actually compared to the text of other user's posts for relevancy and sentiment. In an aspect, the IRCS system 10 tracks a user's posts and analyzes entries to determine what the user means when using certain words, and which terms are relevant to the user. As the user's personal dictionary builds, the intelligence of the system builds.

In order for the relevancy analysis to work properly, though, it is important for the user to be able to train the IRCS system 10. Initially, the IRCS system 10 can only “guess”, particularly if it is looking at natural language with all the colloquialisms and urban uses of a phrase or term. Therefore, the IRCS system 10 provides the ability for the user to “train” the engine to “think” more like the user does. In an aspect, the data learning module 200 can be utilized in the teaching process. For example, the phrase “Hillary Clinton is hot” is ambiguous; we don't quite know if the phrase refers to her appearance, to her rise on the polls, or to how she's feeling at the moment in Savannah, Ga. The IRCS system 10, via the data learning module 200, will automatically guess what the phrase implied. In an aspect, the IRCS system 10 can have the user give hints as to what the user thinks what was really meant, and then, to whether the user agrees with that sentiment or not. The IRCS system 10 can separate semantics (semantics is what we mean) from sentiment (what we feel), and this is a key differentiation. The IRCS system 10 models them with different math, shown in more detail below. This is a key differentiation from other approaches.

Further, the algorithms utilized in this analysis (e.g., the analysis module 300) by the IRCS system 10 are both “pluggable” and the user can weigh the use of those algorithms in levels. For example, with natural language dictionaries, the IRCS system 10 can use urban dictionaries as the first level of “semantics”, a more general dictionary like Wikipedia as the second level, and then a personal dictionary as the third level. The user can customize which dictionary gets the bigger weight when scoring the sentiment, then second, etc., when using them with the scoring algorithm. This can be done by the user of the user device 30 when they agree to use the IRCS system 10 (for example, downloading components (SCPM 35) of the IRCS system 10 onto the user device 30), with the user configuring the IRCS system 10 initially and continuously—the user indicates their preference as to what should be given more importance, the personal dictionary or others. This also means that the IRCS system 10 has the functionality to capture the personal dictionary of the user, forming a “personal search engine”. Where the user can train the IRCS system 10 to recognize results more like what the user expected from the search.

### Semantics

The analysis module 300, via the semantics sub-module 320, of the IRCS server 20 is configured to develop, implement, and capture a variety of different semantic models and algorithms. In an aspect, the analysis module 300 utilizes natural language processing (NLP). NLP is a challenge in and of itself with all the nuances of human language. However, there are additional hurdles to clear as well, including determining the meaning of the language, as well as trying to delve into meaning that spans linguistic boundaries. Even with all of these challenges, true NLP is approaching more and more of a reality. For example, Siri and Cortana have come a long ways, although judging by the fact that both require online connections to work we assume that the processing power is still beyond what fits on our smaller devices.

The analysis module 300, and more specifically the semantics sub-module 320, is interested in the interpretation of natural language, when reading through streams of content, what does the human mean? The word content is used because the IRCS system 10 is not just interested in interpreting written posts on the internet; the IRCS system 10 is configured to build towards an understanding of sounds in music and videos as well, and even terms that may be embedded in images.

In an aspect, the IRCS system 10, and more specifically, the semantics sub-module 320 of the analysis module 300, breaks the analysis down into three: (1) the tokenization and parsing of the content stream; (2) the actual syntactic analysis; and (3) contextual or conceptual mapping. Taking linguistic structures and mapping them to concepts that transcend linguistic barriers is difficult. In many cases, other human factors, such as societal or cultural differences, can create inconsistencies. In addition, the process can involve a transformation, which is an approximation and also prone to machine error. However, given the interactive nature of the IRCS system 10, the human can instruct the machine (i.e., teaching the IRCS system 10), where an algorithm can be refined from the human experience.

The human language is transformed into data, into the bits and bytes that the IRCS system 10 and the analysis module 300 understands, where the algorithms employed by the analysis module 300 then make sense of it all. Semantic trees, semantic characterization, or even more intricate modeling, all need transformed machine-recognizable data stream 80, with computational algorithms that will take the input and transform it into the output.

Because many of people struggle with understanding each other, many times with understanding themselves, a computer can have problems understanding users as well. What is this notion of “understanding”? It is so elusive. The IRCS system 10 is configured to assist users in being able to model themselves, their individual understanding and meaning of things is invaluable (e.g., translating feelings and emotions sentiment).

The semantics sub-module 320 of the analysis module 300 allows the individual to “train” the analysis module's engines/modules/processes into interpreting things the way the person really thinks they are, or the way they feel. The internalization process goes beyond the simple process of customizing the content: it changes the way the actual code, the way the results are processed . . . because even though the input is the same, the output goes to a conversion to a mathematical construct of infinite valuable because math cannot lie.”

### Sentiment

Similar to relevance and semantics, the sentiment sub-module 330 of the analysis module 300 of the IRCS system 10 captures posts, images, videos and other content and analyzes them for sentiment. The content, as discussed above, is converted it to a data stream 80, sent through a sentiment engine/sub-module 330 for analysis, including matching terms, “reading” through the stream to extract the metadata (i.e., the data about the post) and scoring the entry's content. In an aspect, the sentiment sub-module 330 uses a score scale. The use of a scale makes computation extremely faster than actual real numbers in the calculation of negative sentiment. A middle number along a number line is faster to calculate. In an aspect, the score ranges from 1-100, with 1 being negative, 100 being positive, and 50 being neutral. Therefore 1-49 is equal to −49 to −1 in reverse—and 51 to 100 is 1 to 49 positive, eliminating the need for negative values, which can be populated in the wrong places. Using integer math not only increases the speed of processing, it also reduces the costs of such processing.

In an aspect, the IRCS system 10, via the sentiment sub-module 330, uses a variety of public dictionaries (e.g., Urban dictionary, Webster, Wikipedia, etc.), developed personal dictionaries (created by the IRCS system 10) and other similar services to determine the “value” of a term its analyzing in order to capture sentiment base more closely on the user's own use of language and communication patterns.

This scoring of sentiment, while rudimentary, is creating an initial notion of “meaning”, of semantics. Similarly, the sentiment sub-module 330 can be taught by the user of the IRCS system 10. By allowing a human to agree or disagree with the scoring, the sentiment sub-module/engine 330 can “learn” more of what matches the person's sentiment and over time a person can influence results by setting up the system to give the personal sentiment “patterns” a higher weight than those provided by other dictionaries.

In addition, the IRCS system 10 via the sentiment sub-module 330 compares the “patterns”, the “footprints” between different people—as people zero in on shared semantics, the IRCS system 10 can become a way to discover affinities and even to help build consensus on semantically divergent topics. Imagine the circumstance where the semantic scoring of two people is radically different, but somehow, their sentiment analysis matches the other. Perhaps looking at an issue from different perspectives can actually converge semantic divergence based on sentiment.

### Intent

It is one thing to scan content and determine meaning and sentiment, but yet another to create something “new” from those inputs—to determine the intent of the input. The IRCS system 10, and more specifically the intent sub-module 340 of the analysis module 300, analyzes highly intimate and personal inputs to determine the intent of the inputs.

For example, if a person is researching a car, are they intending to purchase a car, or do they just admire those vehicles? Perhaps they already own one and they want to learn more about it, how to maintain it, or improve it. As the IRCS system 10 learns more and more about the user's “reason” for consuming and producing content, the IRCS system 10, via the intent sub-module 340 of the analysis modules 300, can then find more content like it, and even more individuals that can be potential collaborators, mentors, or students. Intent can be found based upon educated guesses which can be corrected by the system, or through providing artifacts to the user (e.g., a like button) to tell the IRCS system 10 when the user intends to acquire or to get rid of something as the most primitive intent specifiers.

### Other Functionality

The IRCS system 10 provides the infrastructure that allows both the anonymous, as well as the secure, personally identifiable information to be used to improve the human condition. In a sense, the IRCS system 10 becomes intelligent by combining human language with machine processing of stored knowledge.

As stated above, most of the data stream 80 moves through the IRCS system 10 without being stored. However, in some aspects, some data is retained as a history of searches and results of an individual, and can be utilized by a personal publishing portal. So a user can create an infographic about the things that are important and relevant to them and display that to the world, invite friends and family, etc. In fact, a person will be able to create different “views” to allow different people to view different aspects of my search.

Another important aspect of the IRCS system 10 is its ability to determine how much system resources are being used by the individual user as well as the aggregate (i.e., when the user of the user device 30 has agreed to let the IRCS system 10 use its resources via a SCPM 35). In fact, this type of instrumentation becomes a critical portion of the IRC system 10 to help determine the cost per user for budgeting purposes. The IRCS system 10 also has a built-in accounting module (not shown) that allows flexibly account for the fair use of resources based on the type of user, or, over time, it allows for customers to purchase more, or better resources based on their usage patterns. The accounting module is a basic part of the IRCS system 10 that tracks cpu, ram and disk usage per user over time—it is an internal accounting module that lets the user know when they are using too many resources—it decides how much resource can be assigned at any one time. In an aspect, the accounting module allows the IRCS system 10 to decide fee schedules for user's use of the system's resources.

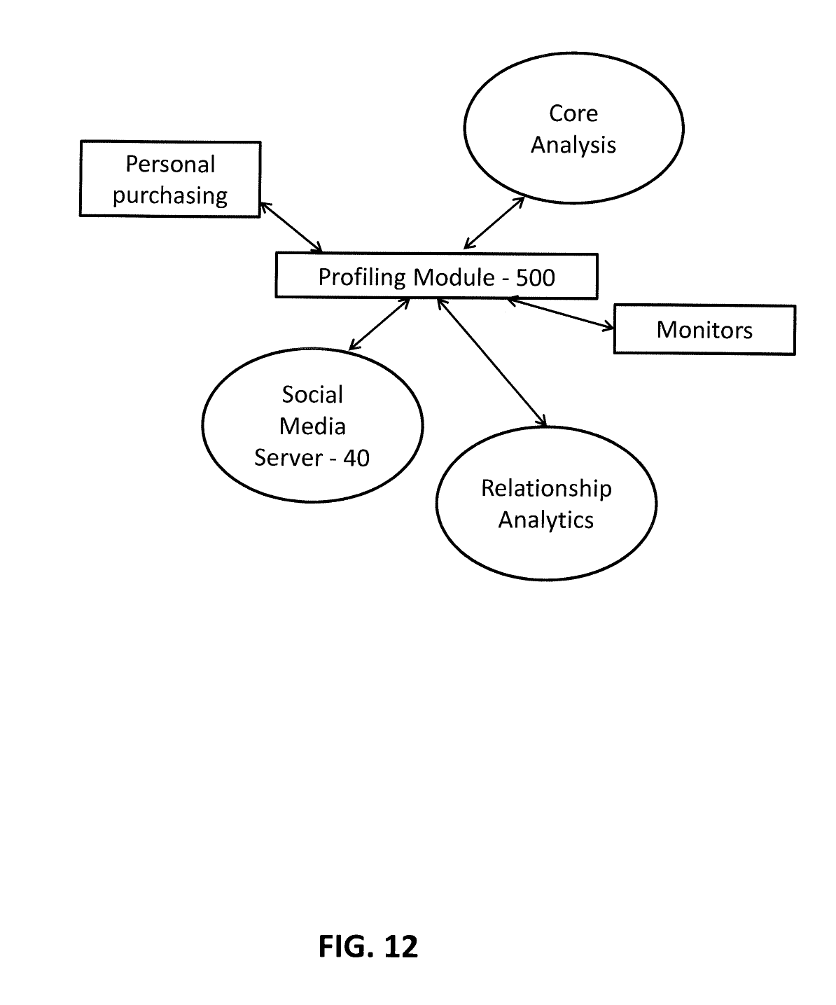

Once the stream 80 is organized into a data model (the data packets consisting of meta data and the post itself) it is available to apply further intelligence. There are four main functions (among others) provided by the data learning module 200 (as shown in FIG. 10 as identifying profiles, patterns, personalization, and reporting), the primary function being finding patterns. As patterns are context sensitive, the engines of the analysis module 300 depend highly on probability algorithms to design pattern pathways, these contextual services (i.e., pattern recognition service) are customized to the knowledge domain—these knowledge domains are also polymorphic—and can be applied across pattern sets. Since the IRCS system 10 is heavily geared towards the individual, it thrives on a personal and group profiling module 500 (see FIG. 12) that builds personalization based on the patterns and intelligence being gathered over time. This time-based intelligence forms the basis for learning in the IRCS system 10. For ultimate flexibility, the intelligence platform provides a flexible reporting platform to customize many aspects required by users and enterprises, allowing monitoring, association of social media platforms with groups or individuals, providing relationship analytics, as well as the core analysis (results from the analysis module 300), and personal purchasing (see FIG. 12).

The platform (i.e., the basic operating environment (See lower layer of FIG. 4)) itself is very light-weight (e.g., streamlined functionality for efficiency purposes) and is there to provide the basic services to allow the different components of the platform to communicate and performs their job, and to enforce a uniform security model. In an aspect, the security model is dependent on the user. The IRCS system 10 can have multiple, unrelated instances, or it can have multiple related instances—ultimately, the goal is to have very little centralized processing and, instead, to have a massively distributed computing, data intelligence platform.

As stated above, the IRCS system 10 can be a distributed system comprised of several user devices 30 employing portions of the IRCS system 10. The goal of distributed systems is to break down problems into byte-sized chunks. For the purpose of solving Big Data problems (Big Data Whales), the IRCS system 10 can implement self-contained processing machines (SCPM) 35 on user devices 30. In an aspect, SCPM 35 can be implemented in hardware, software or both. The SCPMs 35 can be brought together using a volunteer-based network. The SCPM 35 can operate anywhere there are resources available (CPU, Memory, Storage and Network access). The SCPMs 35 can perform any and all of the functions discussed above.

A network of SCPMs 35 distributes processing power and intelligence over different nodes on the network. The SCPMs 35 provides individuals the ability to host “virtual” machines that have low resources consumption and footprint on any device. The footprint can be controlled based upon the size of the dataset to be evaluated by each SCPMs 35. To provide motivation for users and businesses to dedicate portions of their unused resources for supporting SCPMs 35, each can participate in a gamification system that can earn the individual credits and recognition. Companies can reward users, users can reward one another, and the IRCS system 10 can likewise provide incentive to participate in the community from a number of respects.

When a user installs the SCPM 35 on the user device 30, the user has the option to allow community support. In this mode, the SCPM 35 makes minimal use of the user's resources towards this global intelligence brain, while working on the user's own problems and research. In an aspect, the SCPM 35 can be set to work only on a person's own processing tasks until the user enters into community mode. In an aspect, the user can tell the SCPM 35, and the IRCS system 10 in general, a percentage of resources to allocate to his/her problems versus the community. When this is done, the SCPM 35 is training the platform to know their “community spirit” for lack of a better word. Also, as the user is training the data learning module 200, the IRCS system 10 can compare against those concepts that may be building consensus in the community and flag the user as phyllic to the community-accepted concept, or phobic towards it. So it's learning how alike the user is to the world, or not at the same time.

The SCPM 35 doesn't judge in terms of “good or bad” (moral) simply in terms of relevance and significance to the user. This private, secure virtual machine communicates anonymously until the user authorizes it otherwise. In other words, all the work is done without disclosing the user's identity unless the user authorizes its dissemination. In addition, the SCPM 35 is learning and gathering the user's information securely (e.g., sending encrypted data packets), allowing the user to participate, collaborate, and contribute.

When the user provides results to the community, the user can also share her or his “insights” and “opinions” with the world. Unlike known social media platforms, where a person can share just a post, the IRCS system shares the insight about the post. The importance of sharing insights is that sometimes a user's language may be so different from natural language patterns that a positive comment may be interpreted as negative. By training the IRCS system 10 as to what the user “means” and what is relevant to the user, the IRCS system 10 is now able to deliver even better content, even while the user is away. In an aspect, when the IRCS system 10 displays the results of a search, visual cues can be utilized to indicate the conformity to the global sentiment, as well as the lack of In an aspect, the IRCS system 10 can also suggest related topics and searches based on those findings. Even though the IRCS system 10 is not changing the content itself, the IRCS system 10 is presenting in UI artifacts that allow the IRCS system 10 to tell the user what's going on by delivering personalized insights. By sharing her “insights” with the world, the user is sharing more than just her content: the user is sharing the intelligence about her content. In a very real sense, the IRCS system 10 is building a “shared” intelligence cloud. For example, in political campaigns, people can see the user's scoring of discussed topics compared to the prevailing public open when that user offers their sentiment on social media.

Up to this point, the Internet has been built of information silos created by the different networks (email, social, financial, etc.). The data models are static, and semantics have been buried inside source code deep within applications. The IRCS system 10 brings that intelligence out of these silos, and provides people control over their own resources and their own information; as well as the ability to grow intelligence and create intelligent relationships (networks) with other people who match their criteria. The IRCS system 10 provides a way to make these networks form dynamically, with a purpose. In an aspect, the IRCS system 10 can automatically make the connections, or at least present the matches to the users for the users to confirm a connection. That is what is called intent. Intent allows users to express what they want to accomplish, and the IRCS system 10 allows users to express that intent in a way that others can help the user accomplish that intent.

Beyond the individual, these networks provide the ability to act in groups, in teams, or other collaborative structures. In an aspect, users can form collaborative structures, where they agree to adopt the semantics of that context, creating a shared dictionary, and therefore a shared set of patterns, concepts, and processes. The IRCS system 10 provides levels of ranks and advancements to recognize the leaders both as thought leaders, as well as those that contribute with their resources within the IRCS system 10 community, or within their established relationships. The idea is to measure things, to analyze and to cause change with real data and real information, with less guessing. And if the IRCS system 10 must guess, by capturing the results of those guesses so the system 10 doesn't have to keep repeating the same mistakes. As a person's collected intelligence builds on the IRCS system 10, the IRCS system 10 grows more intelligent with every phone call, every email, etc. And reciprocally, every SCPM 35 of the IRCS system 10 grows more intelligent, forming a viral intelligence.

In an aspect, the entire IRCS system 10, including the SCPMs 35, is facilitated, coordinated, managed, secured, and operated by a private network. When joining the private network, a person is adding the power of their SCPM 35 (which can operate in computers, mobile devices, internet services (blogs, websites, pages, etc)) to the power of the network. This massive processing network can tackle Big Data incrementally. Rules can take care of managing resource commitments, and access controls can take care of making sure data is safeguarded. Through the use of SCPMs 35 over private networks, the IRCS system 10 obfuscates all the important parts of a problem to avoid security problems. If a company wants to limit processing to their corporate resources, then the private network of SCPMs 35 can insure all the data stays within that company's designated resources.

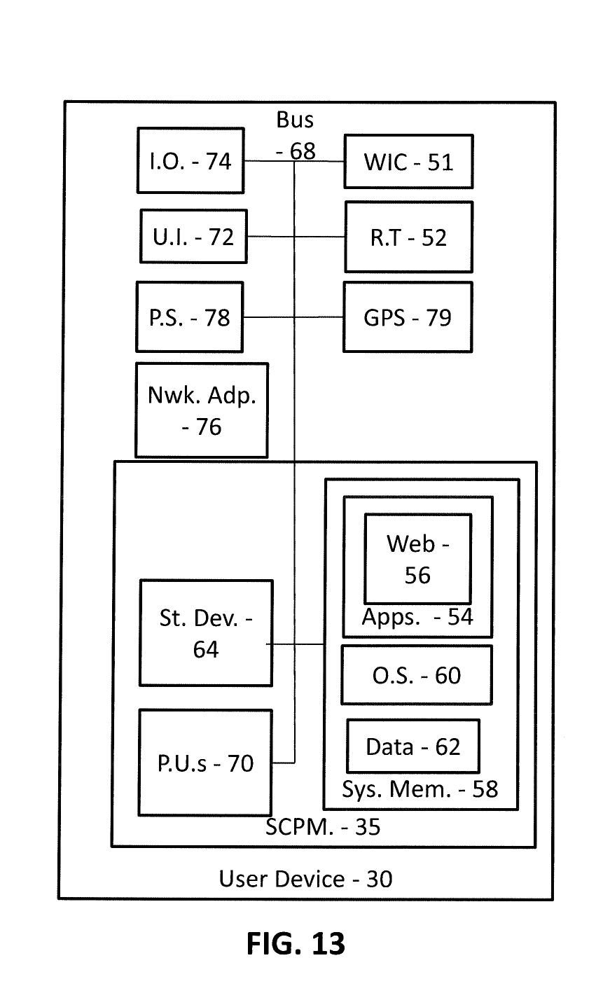

The user devices 30 can include, but are not limited to, personal computers (desktop and laptop), tablets, smart phones, PDA's, hand held computers, wearable computers, and any device that has processing capabilities and access to a network. As shown in FIG. 13, the user devices 30 can include a combination wireless interface controller 51 and radio transceiver 52. The wireless interface controller (W.I.C.) 51 is configured to control the operation of the radio transceiver (R.T.) 52, including the connections of the radio transceiver 52, as well as the receipt and transfer of information from and to the IRCS server 20, social media servers 40, and other servers 50. The radio transceiver 52 may communicate on a wide range of public frequencies, including, but not limited to, frequency bands 2.4 GHz and/or 5 GHz-5.8 GHz. In addition, the radio transceiver 52, with the assistance of the wireless interface controller 51, may also utilize a variety of public protocols. For example, in some embodiments of the present invention, the combination wireless interface controller 51 and radio transceiver 52 may operate on various existing and proposed IEEE wireless protocols, including, but not limited to, IEEE 802.11b/g/n/a/ac, with maximum theoretical data transfer rates/throughput of 11 Mbps/54 Mbps/600 Mbps/54 MBps/1 GBps respectively. In an aspect, the radio transceiver 52 can include a wireless cellular modem 52 configured to communicate on cellular networks. The cellular networks can include, but are not limited to, GPRS, GSM, UMTS, EDGE, HSPA, CDMA2000, EVDO Rev 0, EVDO Rev A, HSPA+, and WiMAX, LTE.

In an aspect, the user devices 30 are configured to communicate with other devices over various networks. The user devices 30 can operate in a networked environment using logical connections, including, but not limited to, local area network (LAN) and a general wide area network (WAN), and the Internet. Such network connections can be through a network adapter (Nwk. Adp.) 76. A network adapter 76 can be implemented in both wired and wireless environments. Such networking environments are conventional and commonplace in offices, enterprise-wide computer networks, intranets, cellular networks and the Internet.

The user devices 30 may have one or more software applications 54, including a web browser application 56 and various others. In an aspect, the user devices 30 can also include the SCPM 35, which can include all of the modules discussed above. The user device 30 includes system memory 58, which can store the various applications 54, including the web browser application 56, as well as the operating system 60. The system memory 58 may also include data 62 accessible by the various software applications 54. The system memory 58 can include random access memory (RAM) or read only memory (ROM). Data 62 stored on the user device 30 may be any type of retrievable data. The data may be stored in a wide variety of databases, including relational databases, including, but not limited to, Microsoft Access and SQL Server, MySQL, INGRES, DB2, INFORMIX, Oracle, PostgreSQL, Sybase 11, Linux data storage means, and the like.

The user device 30 can include a variety of other computer readable media, including a storage device 64. The storage device 64 can be used for storing computer code, computer readable instructions, program modules, and other data 62 for the user device 30, and can be used to back up or alternatively to run the operating system 60 and/or other applications 54, including the web browser application 56 and SCPM 35. The storage device 54 may include a hard disk, various magnetic storage devices such as magnetic cassettes or disks, solid-state flash drives, or other optical storage, random access memories, and the like.

The user device 30 may include a system bus 68 that connects various components of the user device 30 to the system memory 58 and to the storage device 64, as well as to each other. Other components of the user device 30 may include one or more processors or processing units 70, a user interface 72, and one or more input/output interfaces 74. A user can interact with the user device 30 through one or more input devices (not shown), which include, but are not limited to, a keyboard, a mouse, a touch-screen, a microphone, a scanner, a joystick, and the like, via the user interface 72.

In addition, the user device 30 includes a power source 78, including, but not limited to, a battery or an external power source. In an aspect, the user device 30 can also include a global positioning system (GPS) chip 79, which can be configured to find the location of the user device 30.

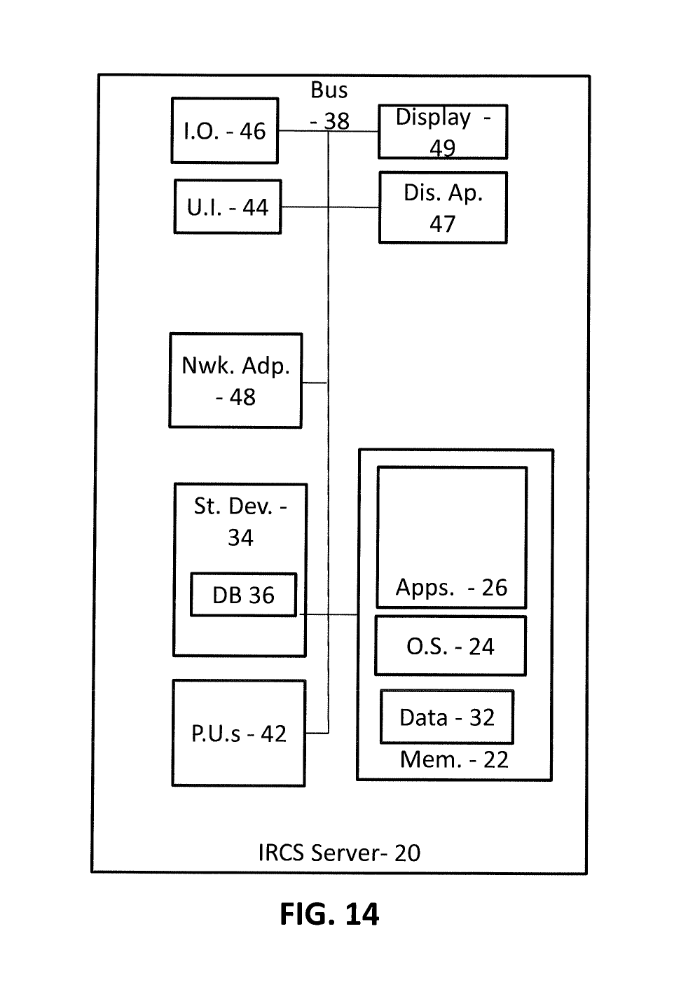

FIG. 14 illustrates an IRCS server 20 according to an aspect. The IRCS server 20, like the user device 30, includes all of the modules discussed above. In general, the IRCS server 20 may utilize elements and/or modules of several nodes or servers. In any event, the IRCS server 20 should be construed as inclusive of multiple modules, software applications, servers and other components that are separate from the user devices 30, social media servers 40, and other servers 50.

The IRCS server 20 can include system memory 22, which stores the operating system 24 and various software applications 26, including the modules discussed above. The IRCS server 20 may also include data 32 that is accessible by the software applications 26. The IRCS server 20 may include a mass storage device 34. The mass storage device 34 can be used for storing computer code, computer readable instructions, program modules (including those discussed above), various databases 36, and other data for the IRCS server 20. The mass storage device 34 can be used to back up or alternatively to run the operating system 24 and/or other software applications 26. The mass storage device 34 may include a hard disk, various magnetic storage devices such as magnetic cassettes or disks, solid state-flash drives, CD-ROM, DVDs or other optical storage, random access memories, and the like.

The IRCS server 20 may include a system bus 38 that connects various components of the IRCS server 20 to the system memory 22 and to the mass storage device 34, as well as to each other. In an aspect, the mass storage device 34 can be found on the same IRCS server 20. In another aspect, the mass storage device 34 can comprise multiple mass storage devices 34 that are found separate from the IRCS server 20. However, in such aspects the IRCS server 20 can be provided access.

Other components of the IRCS server 20 may include one or more processors or processing units 42, a user interface 44, an input/output interface 46, and a network adapter 48 that is configured to communicate with other devices, including user devices 30, social media servers 40, and other servers 50, and the like. The network adapter 48 can communicate over various networks. In addition, the IRCS server 20 may include a display adapter 47 that communicates with a display device 49, such as a computer monitor and other devices that present images and text in various formats. A system administrator can interact with the IRCS server 20 through one or more input devices (not shown), which include, but are not limited to, a keyboard, a mouse, a touch-screen, a microphone, a scanner, a joystick, and the like, via the user interface 44.

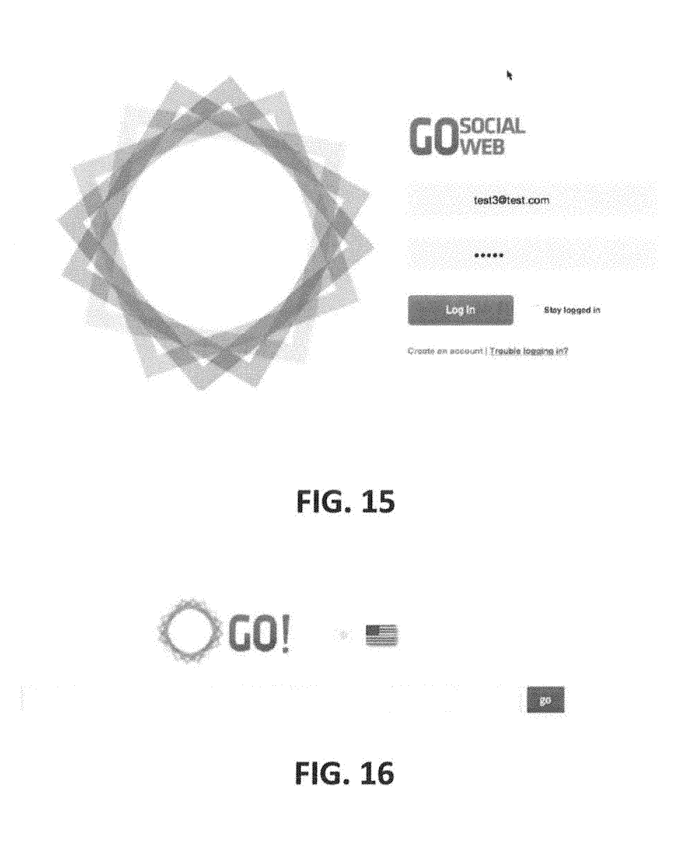

FIGS. 15-20 illustrate screenshots of an implementation of the IRCS system 10 according to one embodiment. In this embodiment, the IRCS system 10 (called “GoSocial”) provides a social analytics tool that can be easily customized for corporate or public use. Unlike Google, however, GoSocial provides an individual's perspective, i.e. what we can learn from their point of view, using their social accounts. This inverted discovery of the social graph provides powerful insights.

user can access the IRCS system 10 through a regular access page as shown in FIG. 15. Once signed in, the interface (see FIG. 16), much like Google, is a very simple search “bar”. While the initial implementation of Go focuses on correlating data from Twitter, Facebook, Flickr and You Tube, it is extremely flexible. New data streams can be easily be added. The data can be structured or unstructured, the algorithms are language independent, the training engine is open and extensible. The idea is that the user interface provides a simple way to “search” the available data streams for the use of tags and terms, when those are discovered, the algorithms score each “post” (can be any grammatical construct presented by the data stream) for sentiment and map a trend over time.

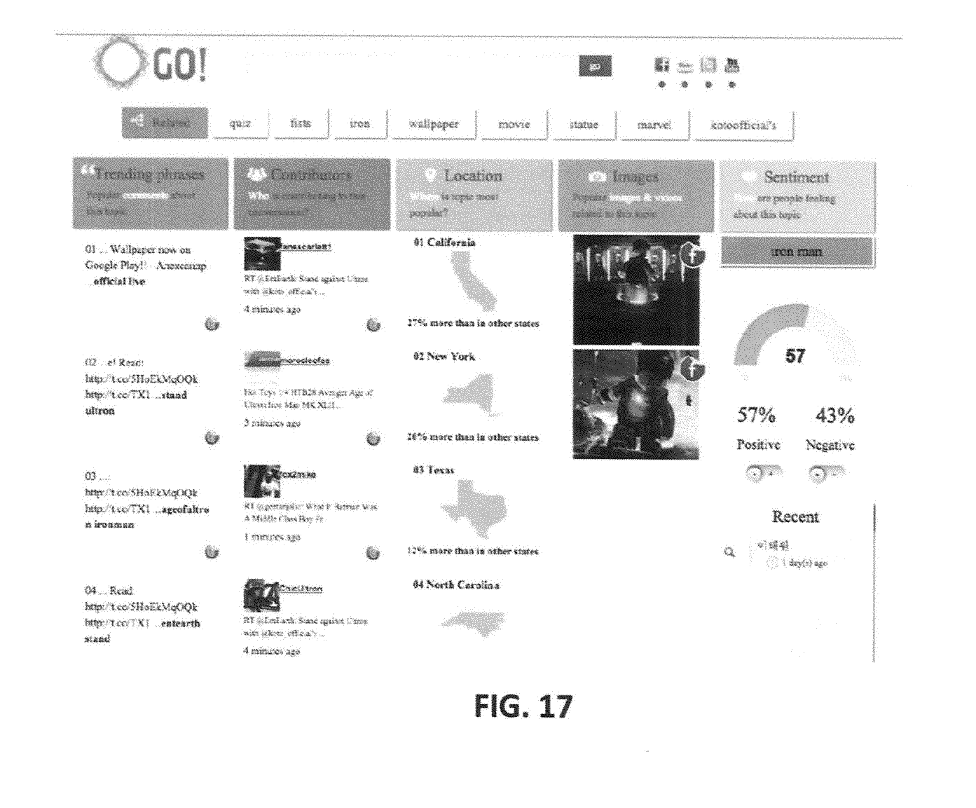

FIG. 17 illustrates search results from the IRCS system 10 using the term “Iron Man” according to an aspect. As shown, at the particular moment in time when the search was performed, it is apparent that the more popular term is the Iron Man character from the Lego Movie, and that generally the sentiment is good. Looking at the tweets there is a recurring post of the wall paper released on Google play. The contributors in the USA are primarily in California or New York and given the timing of the tweets people are actively discussing the topic in the social media networks. Information like this can be invaluable to both the brand owners as well as brand competitors looking to grow their own reputation.

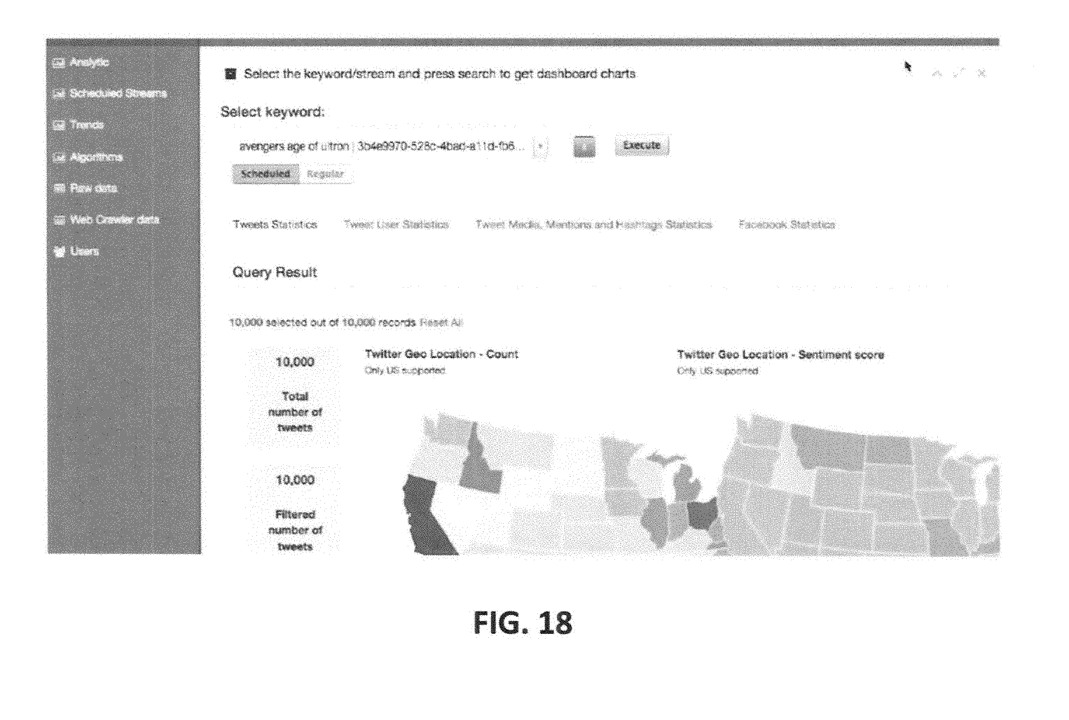

As shown in FIG. 18, the IRCS system 10, via the GoSocial analytic dashboard, provides a powerful interface more suited for managing statistics, trends and analytical projects over time. The IRCS system 10 has better demographic, geographic and infographic capabilities with much better breakdowns by type of device, time of day or week, language, gender, etc. A service like this can be used to monitor locale-sensitive trends such as marketing campaigns, political sentiment, and socio-behavioral analytics.

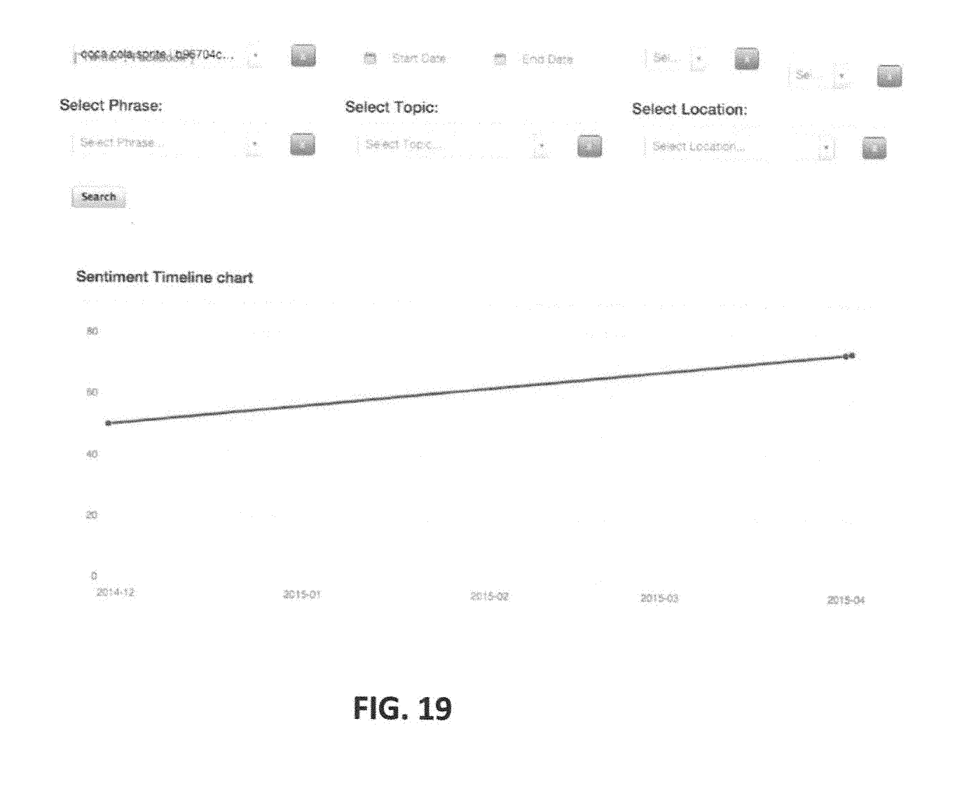

As shown in FIG. 19, by using the sentiment trending capabilities one can look at the volume and variance in sentiment. In this case, the term went from an average score of 50 to almost 80. If someone is watching this happen and it happens unexpectedly one must ask why this happened, or if a campaign is being launched this can indicate the success or failure of such campaign.

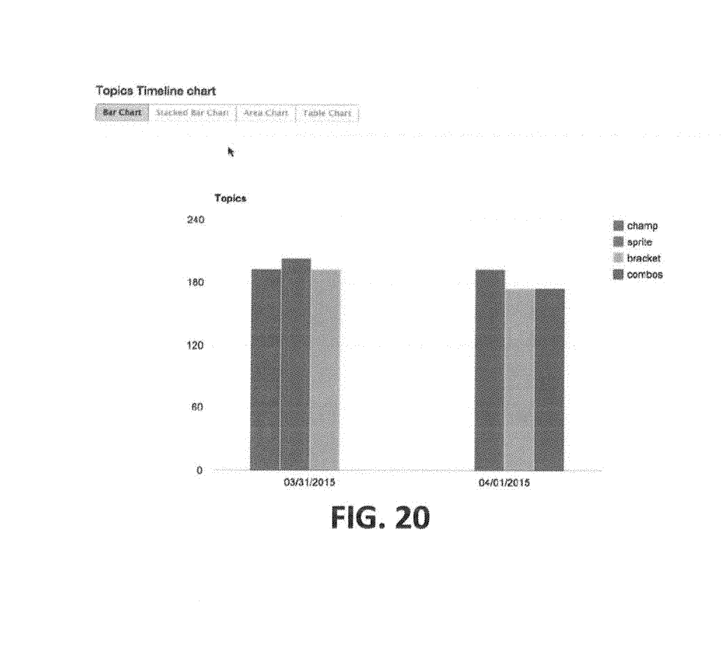

Using different visualization techniques one can observe the movement of trends over a period of time. For example, as shown in FIG. 20, the terms are champ, sprite, and bracket, and combinations of the three. As shown, the most dominant term is sprite and the next relevant term is bracket, which in this case would indicate that over those two days there had to have been some athletic competition where brackets were being monitored and followed in the social circles.

The IRCS system 10 provides the ability to use the “general” public interface to gather and train terms of interest, much like Google does by ranking keywords by search frequency. The IRCS system 10 can be used to track the most searched terms to indicate interest, beyond that, it can be used to aggregate the individual views and sentiment, or it can simply be used to view the “individual's perspective” of a term in the social networks.

Having thus described exemplary embodiments, it should be noted by those skilled in the art that the within disclosures are exemplary only and that various other alternatives, adaptations, and modifications may be made within the scope of this disclosure. Accordingly, the invention is not limited to the specific embodiments as illustrated herein, but is only limited by the following claims.

What is claimed is:

1. An individual relevant content search (IRCS) system configured to return information specific to the individual, the system configured to
a. communicate with at least one user device associated with the individual and social media servers with which the individual utilizes;
b. obtain information from the user device and social media accounts associated with the individual to create a data stream; and
c. analyze the data stream to determine insights of the individual.

2. The IRCS system of claim 1, wherein creating the data stream comprises taking data related to the individual from the social media accounts associated with the individual and assembling the data into a normalized data representation.

3. The IRCS system of claim 2, wherein assembling the data further comprises assembling structured and unstructured data into the data stream.

4. The IRCS system of claim 3, further comprising using domain specific information and metadata to create packets that separate the metadata and content to form the data stream.

5. The IRCS system of claim 2, wherein APIs are used to acquire the structured data and a scraper to acquire the unstructured data.

6. The IRCS system of claim 2, wherein taking the data related to the individual social media accounts further comprises learning the necessary requirements of each social media server to pull the data.

7. The IRCS system of claim 1, wherein the analysis of the data comprises:
i. learning about the data; and
ii. analyzing the data.

8. The IRCS system of claim 7, wherein learning about the data comprises applying concept dictionaries on the data and mapping patterns based upon the concept dictionaries.

9. The IRCS system of claim 8, further comprising applying personal preferences of the individual to the pattern maps.

10. The IRCS system of claim 8, further comprising building personal dictionaries based upon the concept dictionaries and pattern mapping.

11. The IRCS system of claim 7, wherein learning about the data comprises tokenizing the data.

12. The IRCS system of claim 7, wherein analyzing the data comprises determining relevance of the data.

13. The IRCS system of claim 7, wherein determining the relevance of the data comprises grouping terms from the data together and ranking the terms.

14. The IRCS system of claim 13, wherein ranking the terms comprises creating values for the terms.

15. The IRCS system of claim 14, wherein creating the values further comprises measuring the frequency and density of the terms.

16. The IRCS system of claim 7, wherein analyzing the data further comprises determining semantics of the data.

17. The IRCS system of claim 16, wherein determining the semantics further comprises asking the user to train the system.

18. The IRCS system of claim 7, wherein analyzing the data further comprises determining sentiment of the data.

19. The IRCS system of claim 7, wherein analyzing the data further comprises determining intent of the user from the data.

20. The IRCS system of claim 7, wherein analyzing the data further comprises determining relevance, semantics, and sentiment of the data and intent of the user from the data.
